(19) United States
(12) Patent Application Publication
(10) Pub. No.: US 2014/0260898 A1
(43) Pub. Date: Sep. 18, 2014

(54) Musical Note Learning System

(71) Applicants: Joshua Ryan Bales, Washington, PA (US); Lynne Logan, Anaheim Hills, CA (US)

(72) Inventors: Joshua Ryan Bales, Washington, PA (US); Lynne Logan, Anaheim Hills, CA (US)

(21) Appl. No.: 13/999,654

(22) Filed: Mar. 14, 2014

Related U.S. Application Data
(60) Provisional application No. 61/851,954, filed on Mar. 14, 2013.

(51) Int. Cl. G09B 15/02

(52) U.S. Cl. CPC G09B 15/026
USPC 84/433; 84/483.2; 84/479 A

(57) ABSTRACT

A musical note learning system is disclosed. Color coded musical notation sheets include note colors corresponding to similar colors applied or displayed on a musical instrument. The color coded musical notation sheets may include directional indicator symbols corresponding to sharp or flat notes to be played on the instrument. The musical notation sheets may also include chord indicator symbols corresponding to chords to be played on the instrument.

### CROSS-REFERENCE TO RELATED APPLICATION

This application claims the benefit of U.S. Provisional Patent Application Ser. No. 61/851,954 filed Mar. 14, 2013, which is incorporated herein by reference.

### FIELD OF THE INVENTION

The present invention relates to musical instruments, musical instruments designed to facilitate musical training, and systems designed to teach musical instrument proficiency.

### BACKGROUND INFORMATION

Learning to play a musical instrument can provide many challenges to a novice. For example, a new piano player must not only learn musical notation, but must also learn which keys correspond to certain notes. Typical music instruction requires either personal instruction or a great deal of trial and error on the part of the music student. It is therefore an object of the present invention to provide for a method and apparatus to facilitate the learning of musical instruments.

### SUMMARY OF THE INVENTION

The present invention provides color coded musical notation sheets that provide a learning method for music students and others. Color coded musical instruments are also provided, wherein the surfaces to be played are colored in a manner corresponding to notes on the musical notation sheets. In one embodiment, the musical instrument may be a keyboard having keys that are colored or labeled with a color so as to correspond with colored notes on a music sheet. Such a system allows novice musicians to play songs without spending the requisite time to learn musical notation, or may facilitate the learning of traditional musical notation, while allowing the students to play desired songs in the process.

An aspect of the present invention is to provide a musical notation and instrument system comprising: (a) a color coded musical notation sheet comprising: (i) multiple note symbols having different colors, wherein each of the different symbol colors corresponds to a natural note in an octave; and (ii) at least one directional indicator symbol corresponding to a flat or sharp note in the octave; and (b) a musical instrument comprising selected portions, wherein each of the selected portions is identified by an instrument color substantially the same as the symbol color of a corresponding one of the note symbols.

Another aspect of the present invention is to provide a musical notation and instrument system comprising: (a) a color coded musical notation sheet comprising: (i) multiple note symbols having different colors, wherein each of the different symbol colors corresponds to a note in an octave; and (ii) at least one chord indicator symbol corresponding to multiple notes in the octave comprising at least one color substantially the same as at least one of the different note symbol colors; and (b) a musical instrument comprising selected portions, wherein each of the selected portions is identified by an instrument color substantially the same as the symbol color of a corresponding one of the note symbols.

A further aspect of the present invention is to provide a musical notation and keyboard system comprising: (a) a color coded musical notation sheet comprising multiple note symbols having different colors, wherein each of the different symbol colors corresponds to a natural note in an octave; and (b) a keyboard comprising multiple movable keys, wherein each of the keys can be illuminated by a key color substantially the same as the symbol color of a corresponding one of the note symbols.

Another aspect of the present invention is to provide a color coded musical notation sheet comprising: (a) multiple note symbols having different colors, wherein each of the different symbol colors corresponds to a natural note in an octave; and (b) at least one directional indicator symbol corresponding to a flat or sharp note in the octave.

A further aspect of the present invention is to provide a color coded musical notation sheet comprising: (a) multiple note symbols having different colors, wherein each of the different symbol colors corresponds to a note in an octave; and (b) at least one chord indicator symbol corresponding to multiple notes in the octave comprising at least one color substantially the same as at least one of the different note symbol colors.

Another aspect of the present invention is to provide a color coded musical instrument comprising selected portions identified by different instrument colors, wherein each of the instrument colors is substantially the same as a symbol color of a color coded musical notation sheet, and wherein the color coded musical notation sheet comprises: (a) at least one directional indicator symbol corresponding to a flat or sharp note of the musical instrument; or (b) at least one chord indicator symbol comprising at least two colors substantially the same as at least two of the different instrument colors.

A further aspect of the present invention is to provide a color coded keyboard comprising multiple movable keys, wherein each of the movable keys can be illuminated by a different key color that is substantially the same as a note symbol color displayed on a musical notation sheet.

These and other aspects of the present invention will be more apparent from the following description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a color coded musical notation sheet including directional indicator symbols in accordance with an embodiment of the present invention.

FIG. 2 illustrates a color coded musical notation sheet including directional indicator symbols and chord indicator symbols in accordance with an embodiment of the present invention.

FIG. 3 illustrates a keyboard with colored stickers applied to the keys thereof in accordance with an embodiment of the present invention.

FIG. 4 illustrates a color coded musical notation sheet and a color coded keyboard in accordance with an embodiment of the present invention.

FIG. 5 is a schematic flow diagram illustrating a musical note learning system in accordance with an embodiment of the present invention.

FIG. 6 illustrates a color coded musical notation sheet in accordance with an embodiment of the present invention.

FIG. 7 illustrates a color coded musical notation sheet in accordance with an embodiment of the present invention.

FIG. 8 illustrates a color coded musical notation sheet in accordance with an embodiment of the present invention.

FIG. 9 illustrates a color coded musical notation sheet including directional indicator symbols and a color coded keyboard in accordance with an embodiment of the present invention.

FIG. 10 illustrates a color coded musical notation sheet including directional indicator symbols and a color coded keyboard in accordance with an embodiment of the present invention.

FIGS. 11-15 illustrate color coded musical notation sheets including directional indicator symbols in accordance with embodiments of the present invention.

FIGS. 16 and 17 illustrate color coded musical notation sheets including indicators for sharps and flats in accordance with embodiments of the present invention.

FIG. 18 illustrates a color coded musical notation sheet including directional indicator symbols and a color coded keyboard in accordance with an embodiment of the present invention.

FIG. 19 illustrates a color coded musical notation sheet including directional indicator symbols in accordance with an embodiment of the present invention.

FIGS. 20-23 illustrate color coded musical notation sheets in accordance with embodiments of the present invention.

FIG. 24 illustrates a color coded musical notation sheet including a directional indicator symbol in accordance with an embodiment of the present invention.

FIG. 25 illustrates a chord indicator symbol in accordance with an embodiment of the present invention.

FIG. 26 illustrates chord indicator symbols in accordance with embodiments of the present invention.

FIGS. 27-30 illustrate a series of target note indicators in accordance with an embodiment of the present invention.

FIGS. 31 and 32 illustrate different types of target note indicators in accordance with embodiments of the present invention.

FIGS. 33 and 34 illustrate color coded musical notation sheets including de-colorized notes in accordance with embodiments of the present invention.

FIGS. 35-41 illustrate various types of color-coded light up keyboards in accordance with embodiments of the present invention.

FIG. 42 illustrates sequential steps during use of a color-coded light up keyboard in accordance with an embodiment of the present invention.

FIG. 43 illustrates sequential steps during use of a color-coded light up keyboard in accordance with an embodiment of the present invention.

FIG. 44 illustrates sequential steps during use of a color code light up keyboard in accordance with an embodiment of the present invention.

FIGS. 45-47 illustrate different types of keyboard light up configurations in accordance with embodiments of the present invention.

FIGS. 48-54 illustrate different types of color coded musical notation sheets and color-coded light up keyboards in accordance with embodiments of the present invention.

FIGS. 55 and 56 illustrate color coded musical notation sheets and color-coded keyboards in accordance with embodiments of the present invention.

FIG. 57 illustrates a color-coded music sheet for drums in accordance with an embodiment of the present invention.

FIG. 58 is an overhead view of a set of drums including color-coded portions in accordance with an embodiment of the present invention.

FIG. 59 illustrates a guitar with color-coded strings in accordance with an embodiment of the present invention.

FIG. 60 illustrates a guitar with a color-coded fret board in accordance with an embodiment of the present invention.

FIGS. 61-89 illustrate various color-coded keyboard markings in accordance with embodiments of the present invention.

FIGS. 90 and 91 illustrate keyboards with different types of color arrangements in accordance with embodiments of the present invention.

FIGS. 92-96 illustrate color coded musical notation sheets including directional indicator symbols and chord indicator symbols in accordance with embodiments of the present invention.

FIGS. 97-102 illustrate exemplary instruction pages for musical note learning systems of the present invention.

FIG. 103 illustrate various types of chord indicator symbols in accordance with embodiments of the present invention.

FIG. 104 illustrates various types of chord indicator symbols in accordance with embodiments of the present invention.

### DETAILED DESCRIPTION

In accordance with embodiments of the invention, a musical note learning system is color coded, allowing music students and others to familiarize themselves with the placement of musical notes and the corresponding keys or other locations on instruments to be played. In certain embodiments, typical whole, half, quarter, eighth notes, etc. may simply be colored, allowing a student to eventually learn to play without color coding. The present invention may permit a novice to learn songs without the complicated notation systems currently used.

In one embodiment, colored shapes may be placed along a musical staff with shapes which do not necessarily correspond to typical whole, half, or quarter notes. As an example, such a system may utilize a directional indicator symbol such as a triangle pointer, e.g., a triangle accidental, to indicate that a sharp or flat note should be played. In such an embodiment, the directional indicator symbols may indicate the direction on a keyboard from the basic note the music student should play in order to receive the desired sound. In other embodiments, arrows or other directional indicator symbols may be used in place of triangle pointers. In other embodiments, accidentals may be indicated with typical sharp or flat notation, but which is colored to correspond to a note.

In some embodiments of a color-coded music learning system, additional symbols such as note letters, Braille code, or finger numbers may be utilized to facilitate ease of use. In such embodiments, the numbers 1-5 may correspond to the fingers on each of a user's hands to use. Such an embodiment may be designed to demonstrate not only the proper notes to be played, but the proper manner in which to play the notes for maximum proficiency. Such symbols may appear on music sheets, physical keys, on-screen virtual keys and/or LEDs on the instrument to be played.

In certain embodiments of the present musical note learning system, a chord indicator symbol may be used which represents a chord or other combination of notes to be played simultaneously. Such chord indicator symbols may be represented by miniature graphical representations of a keyboard or other instrument, or may simply be a field of multiple colors, each of which corresponds to a note in the chord. In other embodiments, the chord indicator symbol may include a single color corresponding to one of the notes in a chord.

In certain embodiments of the present invention, the musical note learning system may comprise advanced music sheets, which may comprise target note indicators pointing to or highlighting a specific note or chord indicating that it is time or almost time for a player to press a key. In some embodiments, such an indicator may be an arrow, or may be indicated by de-colorized previously played notes. In such embodiments, target note indication may advance at a preset time, or may be responsive to action taken by the player or student.

Whereas some embodiments may comprise elements within music sheets, other embodiments may comprise programmable and/or light up instruments such as a piano keyboard. Such interactive instruments may comprise differing song modes and program modes to more readily adapt to the student's needs. Such modes may include watch and play mode, chord learning mode, interval learning mode, scale learning mode, chord progression mode, and record mode. In addition to modes which permit a student to learn differing aspects of a musical instrument, other modes allow the student or player to learn musical timekeeping or tempo.

In accordance with embodiments of the present invention, customized musical instruments may be provided with system-specific parts, components and operations. Such parts may comprise color-coded light up instrument components, such as piano keys, and may comprise any one of a number of variations for lighting the instrument components, such as single color light up keys and multi-color LEDs encapsulated within a key. Depending on the type of musical notation being taught, or the song being played, such light-up components could vary in colors, lighting methods, or brightness to indicate differing features or notes within the system. Other components may include customizable color sets in the form of labels, stickers, and interchangeable keys.

In some embodiments of the musical note learning system, the system-specific instruments may comprise screens, lights, or other indicators on the instrument, but separate from the keys which may convey necessary information. Such screens or lights may vary in size and can span the entire length of the instrument, or may be smaller. A musical note learning system may also comprise tools for composing music or for transcribing music in order to be played according to a color-coded system.

Although certain embodiments of a musical note learning system may be directed towards instruction for a piano or keyboard, the system can be applied to any one of a number of instruments. Possible embodiments include, but are not limited to, percussion instruments, stringed instruments, wind instruments, and configurations for multiple instrument use. For example, an embodiment of the system implemented on a guitar may comprise a fret board which is passively color-coded over the guitar neck. Other embodiments of such guitar modifications may include stickers or labels to be placed on a guitar.

As used herein, “basic music sheet” means a color-coded music sheet in print form or digital form with passive properties. “Deluxe music sheet” means a color-coded music sheet in digital form with active properties. “Traditional rhythmic notation” means that rhythm is indicated by note shape and stem shape. “Chord symbol” means the root note and quality of the chord to be played. “Target note” means a note that indicates it is time to press the corresponding key. “Target key” means a key that indicates to the player that it is time for that key to be pressed. “Group of target keys” means a group of keys that is lights up at the same time and has requirements a player must fulfill before a new group of target keys gets activated. “Song modes and program modes” means any and all modes may work in conjunction with all variations of piano keyboards (physical and digital), music sheets, instruments, applications, and other devices. “Free time mode” means a default tempo mode, which allows a player to benefit from progressing at a flexible pace. “Steady tempo mode” means progression at an adjustable, but steady tempo. “Accidental” means a symbol that indicates to play a key to the right or left of a key that corresponds to a given note color.

FIGS. 1 and 2 illustrate embodiments of color coded musical notation sheets that correspond with matching piano key colored stickers as shown in FIG. 3.

FIG. 1 illustrates color-coded and simplified notation on a grand staff with directional indicator symbols D. FIG. 2 illustrates a simulated book style with bass clef notes represented as color-coded chord indicator symbols C, above the treble clef, and including directional indicator symbols D. The colored notes may be available in large note sizes or small note sizes, as well as various notation styles. The music sheets shown in FIGS. 1 and 2 may be in print form. Alternatively, the music sheets may be provided in digital form, and may be available in the same various notation styles as in print form. The digital note sizes may be user adjustable.

FIG. 3 illustrates color matching stickers or decals applied to the keys of a keyboard. In the embodiment shown, the order of the colors is: yellow Y; green G; blue B; purple Pu; pink Pi; red R; and orange O. In FIG. 3, the stickers cover only the white piano keys. The stickers may come with an applicator for easy, even transfer onto keys, or may comprise cling vinyl, pressure sensitive adhesive, or the like. For example, the stickers may include paper thin, die-cut vinyl that stick to the keys by adhesion, magnetic labels placed onto magnetized piano keys, plastic or rubber decals, or paper labels. The cling vinyl or other types of stickers may be made of solid colors, and may be opaque, partially transparent or fully transparent. The cling vinyl or other types of stickers may optionally include symbols such as note letters printed on them.

In accordance with an embodiment, the musical notation sheets may be displayed on a screen. The digital notation sheet may contain embedded program data for integrating with piano keyboards, for example, for instructing keys to illuminate or colorize in response to user input data, as well as other user interaction.

In certain embodiments, the musical instrument comprises a basic color-coded light up piano keyboard including a color illumination guide. Color LEDs may illuminate the translucent white keys. The keys may remain lit, allowing the user to match color-coded music notes to the correct keys with extreme ease. The brightness of the LEDs may be adjustable by the user. The colored illumination effect may be de-activated for the appearance of a traditional piano keyboard.

In certain embodiments, the musical instrument comprises a deluxe color-coded light up piano keyboard and a deluxe color illumination guide. FIG. 5 is a schematic flow diagram of a color illumination guide process in accordance with this embodiment. In this embodiment, color LEDs may illuminate only the keys that are to be played by the user for a given beat, according to programmed instructions contained within the music sheets. An example of such a music sheet is shown in FIG. 4.

Target keys and groups of target keys may be utilized. A target key is a key that lights up, signaling the user to press it. A group of target keys includes all target keys that are meant to be pressed at the same time. Upon detection of an entire group of target keys in the depressed position simultaneously, all keys' lights turn off, and the next group of target keys illuminate. Extraneous or erroneous keys depressed by the player may or may not sound and/or light up and may or may not prevent the next group of target keys from lighting up, depending upon the user-selected mode setting. This color illumination guide may be available on all platforms that support music sheets.

Another embodiment provides a basic touch screen tablet/e-reader device containing collections of music sheets. Collections of songs or educational instruction and finger exercises are provided. The system may be capable of loading and transferring additional music sheet downloads. Easy page turning is facilitated. A touch of the screen or page button turns to the following page or back to the previous page. An auto-scroll option allows for viewing or play-along without having to use hands for page turning. The system may be available in single-screen or dual-screen editions.

A single-screen version may have an approximate size of standard music sheets, e.g., 8½ in.×11 in. A dual-screen version may have approximate screen sizes of standard music sheets, e.g., 8½ in.×11 in., which may provide extended visibility of music notation.

In accordance with another embodiment, a deluxe touch screen tablet contains collections of music sheets. Collections of songs or educational instruction and finger exercises may be provided. The system may be capable of loading additional music sheet downloads. Previously purchased basic music sheets may be converted into deluxe music sheets. This system may be available in single-screen or dual-screen editions having sizes as noted above. A color-coded digital piano application may be provided. This system is useful for travel, musicians on the road, and visual aid for learning in the classroom. With the device turned landscape style, music sheets may be displayed on the top screen while the playable digital on-screen piano app inhabits the bottom screen. This system may integrate with the deluxe color-coded light up keyboard described above to send and receive messages for illuminating keys. The system may connect via MIDI, USB, dock, or other known methods. Easy page turning is provided, and one touch of the screen or page button turns to the following page or back to the previous page. An auto-scroll option may be provided for play-along or viewing without having to use hands for page turning.

Another embodiment provides a basic app for existing mobile devices and operating systems. The system may be used for purchasing and displaying music sheets on-screen. The system may be capable of transferring downloads back and forth between the present devices and applications. Easy page turning is provided, and one touch of the screen or page button turns to the following page or back to the previous page.

Another embodiment provides a deluxe app for existing mobile devices and operating systems. The system may automatically convert previously purchased basic music sheets into deluxe music sheets. The deluxe color-coded light up keyboard may be integrated to send and receive messages for illuminating keys. The system may be used for purchasing and displaying the present music sheets. Downloads may be transferred back and forth between the present devices and applications. Easy page turning is provided, and one touch of the screen or page button turns to the following page or back to the previous page. An auto-scroll option may be provided for viewing or play-along without having to use hands for page turning. The system may contain a color-coded digital piano application. The system is useful for travel, musicians on the road, and for visual aid in the classroom.

FIG. 6 illustrates a color code with traditional rhythmic notation. The note shapes and stem shapes indicate duration of notes.

FIGS. 7 and 8 illustrate embodiments of rainbow tie rhythmic notations. A “rainbow tie” is a method of rhythmic notation indicating to extend the duration of the notes that it begins with until the end of the rainbow tie. The rainbow ties may help activate the musical part of the brain. The swirling design of FIG. 7 may provide a musical connotation.

In FIG. 7, the first rainbow tie indicates to extend the duration of the purple, red, and yellow notes all the way through the measure until it is time to play the pink, orange, and green notes. In FIG. 8, the first rainbow tie also indicates to extend the duration of the purple, red, and yellow notes all the way through the measure until it is time to play the pink, orange, and green notes.

In certain embodiments, color-coded accidental symbols are provided. For example, triangle accidentals may be used. Triangle sharps pointing to the right indicate to press the key to the right of the matching color. As shown in FIG. 9, the “sharp” note may indicate a black key or a key of a different color. A triangle sharp may resemble a right pointing arrow, which may help a player intuitively recognize its function. Both the color code and directional indication together may maximize cognitive functioning and minimize coordinative reaction time. Triangle flats pointing to the left indicate to press the key to the left of the matching color. As shown in FIG. 10, the “flat” note may indicate a black key or a key of a different color. A triangle flat may resemble a left pointing arrow, which may help the player intuitively recognize its function. Both the color code and directional indication together may maximize cognitive functioning and minimize coordinative reaction time.

In accordance with another embodiment, the direction indicator symbol may comprise an arrow. Examples of arrow sharps are shown in FIG. 11. Examples of arrow flats are shown in FIG. 12.

In certain embodiments, the sharp symbols are placed after the notes that they modify, as shown in FIG. 13. Such sharp symbols may be placed after the notes to help distinguish sharp notes from flat notes and serve to intuitively remind a player in which direction on the keyboard to diverge from the matching color.

In another embodiment, the directional indicator symbols may accompany a note. Examples of such sharp notes are shown in FIG. 14. Examples of such flat notes are shown in FIG. 15.

In another embodiment, color-coded traditional symbols may be provided, such as the sharps shown in FIG. 16 and the flats shown in FIG. 17.

In accordance with certain embodiments, accidental symbols in a key signature implicitly apply to all occurrences of corresponding notes, for example, as shown in FIG. 18. A player has the option to utilize key signatures or have all accidentals be explicitly applied to each note. Since all corresponding notes that follow the accidentals that exist in a key signature are considered sharp or flat, sometimes it is necessary for a natural symbol to accompany a note on the staff in order to negate the pre-existing accidental, for example, as shown in FIG. 19.

FIG. 20 illustrates a natural symbol variation. FIG. 21 illustrates another natural symbol variation.

In certain embodiments, additional symbols such as note letters, braille code, or finger numbers may be provided. The use of braille code allows blind persons who can read braille code to teach themselves how to play the piano using this system, and may remain consistent with the color coded notes, directional indicators, chord symbols, and other information. As shown in FIG. 22, letters printed on notes provide a player with additional information for learning note names while benefiting from the helpfulness of the colors. As shown in FIG. 23, numbers printed on notes provide a player with guidance when choosing which finger to use to play a certain note. Additional symbols may appear on the music sheets, physical keys, on-screen virtual keys, and/or LEDs or LCD screen on the body of the keyboard. Symbols, as well as colors, may be turned on and off for right hand and left hand independently.

An embodiment provides optional note positioning behind the staff. For example, as shown in FIG. 24, lines over top, or in front, of the notes may make it easier to see which notes are located on lines and which notes are located in spaces.

A further embodiment provides chord symbols that may be in the form of a graphical representation of a keyboard. The keys that are meant to be played at the same time are colorized, for example, as illustrated in FIG. 25. A default chord symbol location may be above the treble clef staff and may replace the bass staff. A player may have the option to have the alter the location of the chord symbol, such as below the treble clef staff.

FIG. 26 illustrates different embodiments of chord symbol indicators of the present invention. The chords that are shown in FIG. 26 have either three or four notes per chord. However, chord symbol indicators corresponding to notes in a chord may be used, e.g., for power chords and the like. Chords with more than four notes may also be used.

In accordance with certain embodiments, deluxe music sheets may be provided with target notes, i.e., a note or modified note that indicates to press a corresponding key. Target notes may be displayed on a screen and may be activated automatically or by a player.

Examples of target note indicators are illustrated in FIGS. 27-30. The indicator may point to or highlight a specific note, chord, beat, or moment in time, indicating that it is time or almost time for a player to press corresponding keys. As a song progresses, the indicator progresses forward with each beat. For example, as shown in FIG. 27, the arrow indicates playing note or note to be played. As shown in FIG. 28, the arrow progresses, indicating next playing note or note to be played. FIGS. 29 and 30 illustrate subsequent note progressions.

The target notes may utilize any number of modes including free time mode, steady tempo mode, etc. In free time mode, new target notes may be activated (indicated) after a player has played all target notes from a previous beat, and a song progresses at the pace of a player. In steady tempo mode, target notes progressively activate at a steady rate according to a specified tempo setting. Some examples of target note indicators include an arrow as shown in FIG. 31, or spotlighted or highlighted target notes as shown in FIG. 32. A target note may be its own indicator, e.g., target notes become colorized when it's time for them to be played as shown in FIG. 33, and target notes become de-colorized after they have been played as shown in FIG. 34.

Embodiments of the invention include customizable color sets. A player may choose from a large selection of colors and arrange the order in which colors correspond to notes and keys. Note colors, stickers, and LED color as well as other program information may be automatically modified to fit a player's customized color set. A default color set may include red, orange, yellow, green, blue, purple, pink. A player may rearrange default colors. A player may select different colors, adjust brightness, hue and saturation levels of colors individually, apply a color spectrum shift adjustment to help with issues relating to color blindness, apply color filters designed to help with issues relating to color blindness, choose to view notes in gray scale, and/or choose to apply design patterns, such as stripes or dots, to notes in place of colors.

In accordance with certain embodiments, editions of musical recordings may have elements removed, such as piano parts, vocals or other instrumental parts, and replaced with light up piano key guides allowing a player to easily follow along and play along to favorite songs. A player may choose which parts to turn on and off.

A deluxe color-coded light up piano keyboard may be provided with song modes and program modes. Song and program modes may utilize any combination or variation of music sheet, target note, target key, etc. Any song or program mode or variation thereof may be utilized in combination with another. A song mode guides a player through a song, and may utilize target keys, target notes, music sheets, and/or LEDs. The song mode may operate in either free time mode or steady tempo mode. A watch and play mode may be provided. When the player presses a key or keys, another key or keys of the same color or colors lights up in a different octave or octaves on the keyboard. For example, watch and play mode setting may include one additional octave as shown in FIG. 35, three additional octaves as shown in FIG. 36, or one additional octave as shown in FIG. 37. A player may be guided when playing octaves with a single hand or when playing the same keys with both hands by aiding in the use of peripheral vision. This system may help a student to learn without having to look over the shoulder of a teacher, in order to see which keys are being played.

In the chord learning mode, a player selects a chord type, such as major, minor, diminished, etc. A player presses any key. The pressed key represents the root note and a chord guide appears, as shown in FIG. 38. With chord mode settings, keys remain lit until a player switches them off, providing ample time to thoroughly practice a chord, get a feel for finger placement, allow muscle memory to form, and for the colorized visual image to solidify in the mind. Activated keys become target keys and remain lit until a player presses them, fulfilling specific requirements of a target mode. A player may create a list of chords that automatically appear in a specified order. The order of scales may also be selected from a preset list such as a circle of fifths. An optional color variation provides a root note color that may be applied to all notes of a chord or scale. For example, an a major triad would consist of three red notes. A c major triad would consist of three yellow notes. Chord mode settings may apply to all song and program modes. An embodiment of the invention includes an interval learning mode. A player may select the size of interval, such as major third, minor third, etc. A player presses any key. The pressed key represents the root note and an interval guide appears, as illustrated in FIG. 39. FIG. 40 illustrates an example of a minor third interval built upon the root note as a player presses a key. In one of the scale learning modes, a player selects a scale type, such as major, minor, etc. A player presses any key. The pressed key represents the root note and a scale guide appears. For example, the E major scale may appear at the touch of a blue key, as shown in FIG. 41. In another scale learning mode, a player selects a scale type and presses any key. The pressed key represents the root note and lights up. It remains lit and waits to be pressed by a player. As the player presses the root note key, the second note in the scale lights up. As the player presses the second key in the scale, the third key in the scale lights up, and so on.

FIG. 42 illustrates steps in such a scale learning mode. Each key in a scale may light up after a player presses it, instead of beforehand. This option is a useful way for a player to test their knowledge of scales after having practiced with the guides. Alternatively, all keys in a scale may light up after a player has played the entire scale correctly from memory.

In another scale learning mode as shown in FIG. 43, a player selects scale type and tempo. A player presses any key. The pressed key represents the root note. The keys of a scale light up one at a time in succession at the specified tempo. A player may observe or play along. The keys become target keys as they light up. A scale repeats until a player has successfully played the entire scale at tempo without playing wrong notes by mistake. The level of difficulty may be adjusted. Keys only light up automatically. Keys only play sound when pressed by a player. In an optional variation, keys also play sound automatically.

In a chord progression mode as shown in FIG. 44, a player selects a type of chord progression, such as I-IV-V. A player presses any key. The pressed key represents the root note. The I chord lights up based upon the root note and waits for a player to play the chord. As a player presses the first chord in the progression, the following chord lights up and waits, and so on as shown in the sequential steps of FIG. 44. A steady tempo mode may be applied using the metronome. A chord progression repeats the cycle until a player has played along with the entire progression with an acceptable level of accuracy. The accuracy level may be adjustable from easy to difficult.

In a record mode, a player's performance is recorded and saved in memory to be recalled at a later time for playback. Recorded information may include light guide playback, sound playback, or a combination of the two. Performances may be recorded within any song or program mode. Free time mode and/or steady tempo mode may be applied. This embodiment enables players to observe their performances through both sight and sound, in order to evaluate and learn where room for improvement exists relating to timing and accuracy, and provides benefits to players as a compositional tool.

In accordance with embodiments of the invention, tempo modes may be provided, including a free time mode and a steady tempo mode. The free time mode may be the default setting for song and program modes, and may provide helpful guidance for a player to learn and progress at a comfortable pace. In the free time mode, a group of target keys lights up and waits to be pressed. Once the entire group has been pressed, a new group lights up and waits. Target keys and groups of target keys may be utilized. A target key lights up signaling the player to press it. A group of target keys are meant to be pressed at the same time. A group of target keys may consist of one or more target keys, and may be satisfied upon detection of the entire group of target keys being in the depressed position at the same time. An erroneous key is a key that is not a target key and produces musical dissonance. An extraneous key is a key that is not a target key and produces musical consonance. If a player strikes an erroneous or extraneous key, the key sounds and lights up but has no effect on the default free time process.

In the default free time mode process, a group of target keys activates (lights up) for a given beat. That group of target keys remains active until a player has satisfied all requirements for deactivating it by pressing the appropriate keys correctly. When an active group of target keys is correctly played, that group of target keys deactivates, and the next group of target keys activates. After the requirements for deactivating a group of target keys have been met, all key LEDs turn off, however a sound produced by a key continues to play until that key has been released from the depressed position.

Variations on free time mode include: non-target keys that are pressed, at the same time as target keys, will prevent the next group of target keys from lighting up; erroneous keys that are pressed, at the same time as target keys, will prevent the next group of target keys from lighting up; a group of target keys is not deactivated until all target keys have been pressed and then also released; a group of target keys is not deactivated until all keys have been released; target key LEDs turn off individually and count toward satisfying the requirements of deactivating a group of target keys without having to be in the depressed position all at the same time. However, new target keys do not activate (light up) until the entire previous group of target keys has been depressed; only fully depressed keys are detected; partially depressed keys are detected; erroneous keys do not light up; extraneous keys do not light up; erroneous keys do not light up or play sound; and extraneous keys do not light up or play sound. Any variation may be combined with another to create additional variations.

The steady tempo mode progresses at a steady rate utilizing a metronome or other synchronized method. It helps a player improve timing accuracy by playing along to a steady beat while being guided by target keys. For example, target keys, groups of target keys, and a metronome may be utilized. In one embodiment of the default steady tempo mode process, a player selects a tempo and starts a song or learning program, hereafter referred to as song. An initial group of target keys lights up and waits to be pressed. As a player presses the initial group of target keys, the song begins and progresses at the specified tempo. A new group of target keys lights up on its designated beat unless a player has deactivated the previous group of target keys before the following beat occurs, in which case the new group of target keys lights up between the beat it is meant to be played on and the previous beat. The earliest that a new group of target keys may light up is just slightly less than one beat early. The latest a new group of target keys can light up is at the time of its designated beat.

An embodiment of the present invention provides color-coded light up piano key components. For example, “white keys” are composed of translucent white colored material, and “black keys” are composed of translucent black colored material. The keys may include shields located under the surface or on the sides for preventing LEDs from bleeding through into neighboring keys. Color LEDs or similar type bulbs, hereafter referred to as LEDs, may be located inside or below the surface of the key providing backlighting or similar effect. As shown in FIG. 45, one 7-color changing LED may be contained within each key, with default colors consisting of red, orange, yellow, green, blue, purple, and pink. This embodiment may provide maximum flexibility for user-customizable color schemes.

In the embodiment shown in FIG. 46, each white key contains only one single color LED. Each black key contains two different color LEDs or a single dual color LED. One color that matches the “flat” color-coded note, and one color that matches the “sharp” color-coded note for that particular key. This configuration works with a simplified form of music theory and notation, where the “white keys” always remain the same color, yet the “black keys” have a sharp color and flat color.

In the embodiment shown in FIG. 47, one triple color LED is contained within each white key. One that matches the “natural” note, “sharp” note, and “flat” note for a particular key.

Alternatively, one color LED, anywhere from triple color up to seven colors, may be contained within each key in order to match the desired method of musical notation. Furthermore, multiple single color LEDs may be located within each key in order to achieve desired color scheme variation. In another variation, the “white keys” may be composed of translucent material in various colors. Each key is colorized to match a corresponding note. The black keys may be composed of translucent black material. Each “white key” is illuminated with a clear LED. Each black key is illuminated by one color for the “flat” note and a different color for the “sharp” note. In further variation, the “white keys” may be composed of translucent material in various colors. Each key is colorized to match a corresponding note. The “black keys” may be composed of translucent material in various colors. Each black key may be divided into two colors—one color indicating the flat note, and a different color indicating the sharp note. Each key may be illuminated by a clear LED. As another variation, glow-in-the-dark keys may be combined with any or all of the above configurations.

In accordance with embodiments of the invention, various LED operations and variations may be provided. LEDs may be capable of producing multiple levels of brightness. Multiple levels of brightness may be achieved with two or more LEDs of different brightness levels located within each key. Keys may only light up when they become active target keys. All keys may remain dimly lit when idle. Active keys may light up brighter at time of activation. Alternatively, all keys may glow-in-the-dark while idle and light up brighter via LEDs when activated. Furthermore, only “white keys” may remain dimly lit or glow while idle. As a player presses a key, it may light up, depending on the mode. White keys may remain lit at all times, or all keys remain lit at all times. A player may have the option to turn LEDs on or off at any time.

In certain embodiments, notation symbols may be provided on keys. Symbols, such as letters or numbers, may be printed on the keys for additional guidance and learning. Furthermore, braille code may be imprinted on or added to keys. The braille code may represent notes letters, note colors, or other information. The symbols may be applied to keys utilizing stickers or removable decals.

Various piano key color scheme options may be used. For example, a default color set may be red, orange, yellow, green, blue, purple, pink. Alternatively, a custom rainbow color set may be used. A player has the option to rearrange the order of the default colors.

In certain embodiments, LEDs may be located on body of keyboard. A row or rows of color LEDs located above the keys that light up to indicate which target keys are up next in line, as shown in FIG. 48. Alternatively, a row of LEDs including symbols such as note letters, finger numbers, sharp and flat symbols, etc., may be used, or a row of LEDs in various shapes such as keys, accidentals, arrows, etc., may be used. In the embodiment shown in FIG. 49, a row of triangle accidental LED indicators is used. In the embodiment of FIG. 50, a row of key-shaped LED indicators is used. In the embodiment of FIG. 51, multiple rows of LED indicators are used. In the embodiment of FIG. 52, a double row of key-shaped LED indicators above the playable keys are used. Rows of LED indicators may be switched on or off individually or all at once.

In one embodiment, an LCD screen may be located on the body of a keyboard for displaying various information including color-coded guides. LCD screen size may span the entire length of a keyboard or less, for example, as shown in FIGS. 53 and 54, respectively. In certain embodiments, deluxe touch screen tablet additions may be used, such as a playable virtual piano application, a composer application, user-customized color sets, collections of deluxe music sheets capable of loading additional music sheets, integration with deluxe keyboard via dock, adapter, cable, or other method, stereo headphone jacks, built-in speakers, metronome, etc.

An embodiment of the invention provides a deluxe app for mobile devices, playable virtual piano application, composer application, user-customized color sets, collections of deluxe music sheets capable of loading additional music sheets, integration with deluxe keyboard via dock, adapter, cable, or other method, metronome, etc.

A further embodiment provides a color-coded music and lighting composer application. A player may place a note on the staff by dragging, clicking, or touching the staff at the desired position. A note plays its corresponding sound as it appears on the staff. Notes may continue to be added or deleted. When connected to the deluxe or virtual piano keyboard, a player may record and save a performance. The composition may be played back with sound and/or color-coded lighting guide. The composition may be exported and saved or printed as a color-coded music sheet. An example of a color-coded music and lighting composer in shown in FIG. 55. A composer version utilizing traditional rhythmic notation is shown in FIG. 56.

In accordance with certain embodiments, a non-light up color-coded keyboard is provided, e.g., a keyboard with color-coded keys. Each white key may be color-coded to its matching note color. For example, seven default colors may repeat in the same order for each octave. Alternatively, color-coded white keys and black keys may be provided. Each black key may be colorized with two colors. The same default colors may be utilized. One color corresponds to the flat note. Another color corresponds to the sharp note. In a further variation, white keys and black keys may be each assigned a separate color, e.g., twelve colors may be utilized. The colors may repeat in the same order for each octave. In another variation, removable keys allow a player to rearrange color order. Furthermore, the keys may be glow-in-the-dark, or stickers or removable decals may be applied to add symbols and information to keys.

Embodiments of the present invention include drums and percussion instruments. For example, color-coded drums and matching color-coded music sheets may be provided. A colored ring may be placed on the inner/outer rim of a drum, or on a drum head. Glow-in-the-dark rings may be provided. A pre-colored rim for each drum, or a pre-colored form-fitting rim cover may be used. An LED may be placed inside a drum that shines through translucent drum head/shell. For cymbals, colored rings may be placed on the bell or outer rim of a cymbal, a colored wing nut may be attached to cymbal stand, or a colored felt piece may be placed between cymbal and wing nut. Additional materials include: sticker/removable decals; vinyl or die-cut vinyl; magnetic; rubber; plastic; and LED or fiber optic.

In certain embodiments, an active drum system is provided. For example, an LED may light up a target drum signaling a player to strike it. A sensor attached to a drum detects when a drum has been struck. After a drum has been struck, the next drum to be played lights up signaling a player to strike it.

Methods for color-coding drum and percussion music sheets include a default color code in which standard black is used to indicate the most frequently played drums, such as the bass drum, snare drum, and hi-hats. Standard black may also be used when less frequently played drums are notated far apart one another vertically on the music staff. Colors may be used to make less frequently played drums stand out, such as tom-toms and crash cymbals. This makes it easier for the player to see which notes are coming up ahead. Colors may also be used to provide distinction between notes that are printed close to one another vertically on the music staff.

An example of a color-coded music sheet for drums is shown in FIG. 57.

An overhead view of a set of drums is shown in FIG. 58.

Customizable color codes may be used. For example, a player may have the option to choose which drums to be colorized and which color to assign to each drum and matching note.

In accordance with certain embodiments, string instruments may be used. For example, color-coded strings and matching color-coded music sheets may be provided. In a passive method, strings may be dyed with colored ink, which may be fluorescent. Fiber optic light up strings may be used. The strings may be backlit by LEDs. The strings may glow-in-the-dark. A color-coded sticker or removable decal/label may be placed on the neck of the guitar. The guitar may include a pre-colorized fret board. Color-coded fabric or flexible plastic material may be used that wraps around the neck of a guitar and fastens together on the back with Velcro, snaps, buttons, ties, or other method. A clip-on hard or soft plastic color-coded fret board may be used. A clip-on plastic color-coded fret board with LEDs may be used.

In an active mode, a target string is a section of a string that when activated, lights up to signal it is time to be played. Once the target string has been played, it deactivates and a new target string activates. FIG. 59 illustrates an example of color-coded strings. FIG. 60 illustrates an example of a color-coded fret board.

In certain embodiments, wind instruments are provided. The wind instruments may be color-coded with matching color-coded music sheets. For example, valves, keys, slides, and buttons of various wind instruments may be color-coded to match corresponding musical notation.

FIGS. 61-89 illustrate various examples of applying stickers, removable decals, physical keys, LEDs, and/or virtual keys. A default color set is shown in FIG. 61. Variations are shown in FIGS. 62-89.

FIGS. 90 and 91 illustrate color variations for keyboards. In FIG. 90, the colors are arranged from left to right as: yellow Y; green G; blue B; purple Pu; pink Pi; red R; and orange O. In FIG. 91, the colors are arranged from left to right as: orange O; purple Pu; green G; pink Pi; yellow Y; red R; and blue B.

FIG. 92 illustrates a musical notation sheet including directional indicators, chord indicator symbols and tie symbols in accordance with an embodiment of the present invention.

FIG. 93 illustrates another musical notation sheet including directional indicators, chord indicator symbols and tie symbols in accordance with an embodiment of the present invention. In this embodiment, the chord symbols are staggered at different levels in order to differentiate between adjacent chord symbols.

FIG. 94 illustrates a musical notation sheet including directional indicators and chord indicator symbols in accordance with another embodiment of the present invention. In this embodiment, the colored note symbols also include conventional stems.

FIG. 95 illustrates a musical notation sheet including a directional indicator in accordance with an embodiment of the present invention. In this embodiment, a grand staff is provided including bass and treble staffs.

FIG. 96 illustrates a musical notation sheet including directional indicators and chord indicator symbols in accordance with an embodiment of the present invention.

FIGS. 97-102 illustrate exemplary instruction pages that may be used to help instruct users when learning to use the system.

FIG. 103 illustrates a chord guide including embodiments of chord indicator symbols in accordance with embodiments of the present invention. In level 1, the chord indicator symbols appear as keyboard keys. In level 2, the chord indicator symbols are colored bars, which may also include directional indicators. In level 3, the chord indicator symbols include a single color, e.g., representing which note of the chord is to be used as the root note, with a letter indicating a particular combination of notes in the chord.

FIG. 104 illustrates another chord guide including embodiments of chord indicator symbols similar to those shown in FIG. 103, with the addition of first and second inversions.

Whereas particular embodiments of this invention have been described above for purposes of illustration, it will be evident to those skilled in the art that numerous variations of the details of the present invention may be made without departing from the invention as defined in the appended claims.

What is claimed is:

1. A musical notation and instrument system comprising:
(a) a color coded musical notation sheet comprising:
(i) multiple note symbols having different colors, wherein each of the different symbol colors corresponds to a natural note in an octave; and
(ii) at least one directional indicator symbol corresponding to a flat or sharp note in the octave; and
(b) a musical instrument comprising selected portions, wherein each of the selected portions is identified by an instrument color substantially the same as the symbol color of a corresponding one of the note symbols.

2. The musical notation and instrument system of claim 1, wherein the musical instrument comprises a keyboard and the at least one directional indicator symbol corresponds to a black key of the keyboard.

3. The musical notation and instrument system of claim 2, wherein the selected portions of the keyboard comprise natural keys displaying the instrument colors.

4. The musical notation and instrument system of claim 3, wherein the instrument colors are displayed on the natural keys in the form of colored stickers covering at least a portion of each of the natural keys.

5. The musical notation and instrument system of claim 3, wherein the instrument colors are displayed on the natural keys in the form of colored cling vinyl covering at least a portion of each of the natural keys.

6. The musical notation and instrument system of claim 3, wherein the instrument colors are displayed on the natural keys by illuminating each of the natural keys with a selected one of the instrument colors.

7. The musical notation and instrument system of claim 1, wherein the musical instrument comprises a keyboard including keys that are movable when struck by a user.

8. The musical notation and instrument system of claim 1, wherein the musical instrument comprises a touch screen display of a keyboard.

9. The musical notation and instrument system of claim 1, wherein the color coded musical notation sheet comprises a printed sheet.

10. The musical notation and instrument system of claim 1, wherein the color coded musical notation sheet comprises an electronic display screen.

11. The musical notation and instrument system of claim 1, wherein the color coded musical notation sheet further comprises at least one chord indicator symbol corresponding to at least two of the natural notes in the octave, and the cord indicator symbol comprises a color substantially the same as one of the instrument colors.

12. The musical notation and instrument system of claim 1, wherein the color coded musical notation sheet further comprises at least one chord indicator symbol corresponding to at least two of the natural notes in the octave, and the cord indicator symbol comprises at least two colors substantially the same as at least two of the instrument colors.

13. A musical notation and instrument system comprising:
(a) a color coded musical notation sheet comprising:
(i) multiple note symbols having different colors, wherein each of the different symbol colors corresponds to a note in an octave; and
(ii) at least one chord indicator symbol corresponding to multiple notes in the octave comprising at least one color substantially the same as at least one of the different note symbol colors; and
(b) a musical instrument comprising selected portions, wherein each of the selected portions is identified by an instrument color substantially the same as the symbol color of a corresponding one of the note symbols.

14. The musical notation and instrument system of claim 13, wherein the at least one chord indicator symbol comprises at least two colors substantially the same as at least two of the different note symbol colors.

15. The musical notation and instrument system of claim 14, wherein the multiple notes in the octave are selected from natural notes in the octave.

16. The musical notation and instrument system of claim 14, wherein the multiple notes in the octave are selected from a combination of natural notes in the octave and at least one flat or sharp note in the octave.

17. The musical notation and instrument system of claim 14, wherein the multiple notes in the octave are selected from flat or sharp notes in the octave.

18. The musical notation and instrument system of claim 14, wherein the musical instrument comprises a keyboard including multiple keys, each instrument color is displayed on a separate key of the keyboard, and the at least two colors of the at least one chord indicator symbol correspond to at least two of the instrument colors displayed on the keys.

19. The musical notation and instrument system of claim 14, wherein the color coded musical notation sheet further comprises at least one directional indicator symbol corresponding to a flat or sharp note in the octave.

20. A musical notation and keyboard system comprising:
(a) a color coded musical notation sheet comprising multiple note symbols having different colors, wherein each of the different symbol colors corresponds to a natural note in an octave; and
(b) a keyboard comprising multiple movable keys, wherein each of the keys can be illuminated by a key color substantially the same as the symbol color of a corresponding one of the note symbols.

21. A color coded musical notation sheet comprising:
(a) multiple note symbols having different colors, wherein each of the different symbol colors corresponds to a natural note in an octave; and
(b) at least one directional indicator symbol corresponding to a flat or sharp note in the octave.

22. A color coded musical notation sheet comprising:
(a) multiple note symbols having different colors, wherein each of the different symbol colors corresponds to a note in an octave; and
(b) at least one chord indicator symbol corresponding to multiple notes in the octave comprising at least one color substantially the same as at least one of the different note symbol colors.

23. A color coded musical instrument comprising selected portions identified by different instrument colors, wherein each of the instrument colors is substantially the same as a symbol color of a color coded musical notation sheet, and wherein the color coded musical notation sheet comprises:
(a) at least one directional indicator symbol corresponding to a flat or sharp note of the musical instrument; or
(b) at least one chord indicator symbol comprising at least two colors substantially the same as at least two of the different instrument colors.

24. A color coded keyboard comprising multiple movable keys, wherein each of the movable keys can be illuminated by a different key color that is substantially the same as a note symbol color displayed on a musical notation sheet.
